(19) United States
(12) Patent Application Publication
(10) Pub. No.: US 2012/0326341 A1
(43) Pub. Date: Dec. 27, 2012

(54) METHOD FOR FABRICATING SELF ASSEMBLING LIGHT EMITTING DIODE LENS

(75) Inventors: Tzu-Chi CHENG, Yangmei (TW); Charles Owen Edwards, Rio Rancho, NM (US); Chien-Li Yang, Yangmei (TW); Yu-Min Li, Yangmei (TW)

(73) Assignee: INTEMATIX TECHNOLOGY CENTER

(21) Appl. No.: 13/166,953

(22) Filed: Jun. 23, 2011

(51) Int. Cl. B29D 11/00

(52) U.S. Cl. 264/1.1

(57) ABSTRACT

A method for fabricating a self assembling light emitting diode lens is disclosed. The method includes providing a first fluid with a first viscosity and a second fluid with a second viscosity. The refractive index of the first fluid is the same as the refractive index of the second fluid. Then the first fluid and the second fluid are blended in a predetermined ratio to obtain a third fluid with a third viscosity. Then the third fluid is dispended on a light emitting diode, which is disposed on a substrate. The third fluid is cured to form a lens on the light emitting diode. The shape of the lens is controlled by the third viscosity.

### BACKGROUND

1. Field of Invention

The present invention relates to a light emitting diode lens. More particularly, the present invention relates to a method for fabricating a light emitting diode lens.

2. Description of Related Art

A light emitting diode (LED) is a type of micro solid state light source and has advantages of small volume, preferred resistance to shock, energy saving, long life, and various colors. The LED can meet the requirements of various types of new application, and is a light source which has seen everywhere in daily life. As the luminous efficiency of the LED becomes higher and higher and the color rendering and the color temperature of the LED become better and better and the price of the LED falls, the illumination application field of the LED will become broader and broader.

Optical components, such as lenses, can be used to enhance the LED light emitting efficiency. The shape, the refractive index, and the arrangement of the lens can be designed to improve the luminous flux and the light extraction. However, the cost of the mold for molding the lens will increase. Therefore, there is a need to provide a method for fabricating LED lens without a molding process (reveals motivation, suggest deleting).

### SUMMARY

An aspect of the invention provides a method for fabricating a self assembling light emitting diode lens. The method includes providing a first fluid with a first viscosity and a second fluid with a second viscosity. The refractive index of the first fluid is the same as the refractive index of the second fluid. Then the first fluid and the second fluid are blended in a predetermined ratio to obtain a third fluid with a third viscosity. The third viscosity is from 3000 cps to 300000 cps. Then the third fluid is dispensed on a light emitting diode disposed on a substrate. The third fluid is cured to form a lens on the light emitting diode. The shape of the lens is controlled by the third viscosity.

The step of dispensing the third fluid on the light emitting diode includes filling the third fluid into an injector, positioning the injector, dispensing the third fluid in a predetermined volume, and pulling back the injector. An outlet is submerged by the third fluid when the third fluid is injected in the predetermined volume. In an embodiment, the method further includes adding a phosphor into the third fluid. In an embodiment, the method further includes dispensing a fourth fluid on the lens. In an embodiment, the diameter of the lens is from 0.1 mm to 50 mm. In an embodiment, the material of the first fluid and the second fluid is resin, silicone, epoxy, or polymer. In an embodiment, a curing temperature is preferably from 20° C. to 200° C. In an embodiment, a curing pressure is preferably from 0.1 atm to 5 atm. In an embodiment, the method further includes forming a cavity on the substrate, and the light emitting diode is disposed in the cavity.

The lens is shaped by the viscosity of the fluid, thus the molding process can be omitted. The blending ratio of the first fluid and the second fluid is adjusted to tune the third viscosity, which decides the shape of the lens. A variety of lenses with different shapes can be formed by blending two fluids according to the present invention.

It is to be understood that both the foregoing general description and the following detailed description are made by examples and intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart of an embodiment of the method for fabricating the self assembling light emitting diode lens of the invention;

FIG. 2 is a schematic diagram of an embodiment of the dispensing step of the invention;

FIG. 3 is a flow chart of another embodiment of the method for fabricating the self assembling light emitting diode lens of the invention;

FIG. 4 to FIG. 6 are schematic diagrams of different embodiments of the lens fabricated by the method of the invention;

FIG. 7 to FIG. 10 are schematic diagrams of different embodiments of the complex lens fabricated by the method of the invention;

FIG. 11 is a schematic diagram of the method utilized in a uniform distribution light emitting diode structure;

FIG. 12 is a schematic diagram of the method utilized in a conformal distribution light emitting diode structure;

FIG. 13 is a schematic diagram of the method utilized in a remote phosphor light emitting diode structure.

FIG. 14 is a schematic diagram of a light emitting diode array fabricated by the method of the invention; and

FIG. 15 to FIG. 16 are schematic diagrams of different embodiments of the light emitting package structure fabricated by the method of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The invention provides a method for fabricating a variety of lenses by blending two fluids with different viscosities in different ratios. The viscosity of the blended fluid can be predetermined according to the desired shape of the lens, which is formed by curing the blended fluid without any molding process.

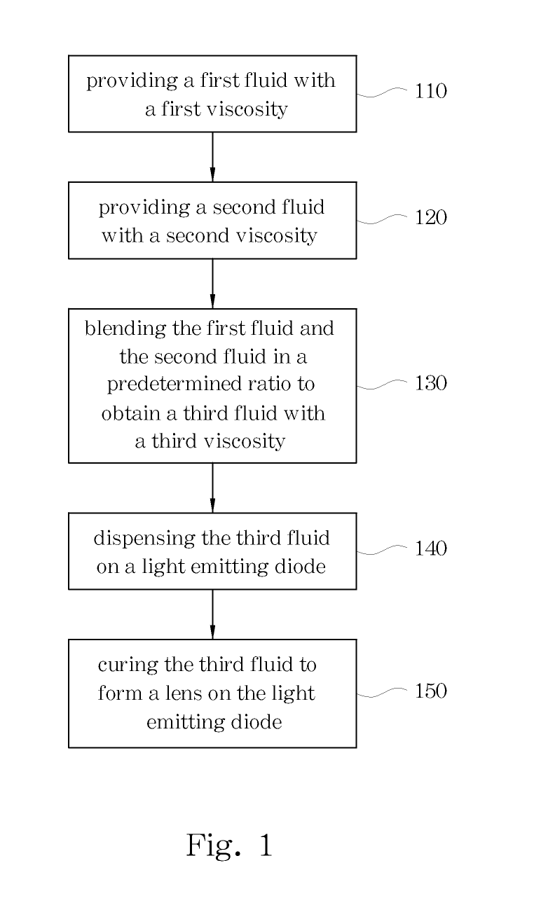

Refer to FIG. 1. FIG. 1 is a flow chart of an embodiment of the method for fabricating the self assembling light emitting diode lens of the invention. In step 110 a first fluid with a first viscosity is provided. In step 120 a second fluid with a second viscosity is provided. The refractive index of the first fluid is the same as the refractive index of the second fluid. The first viscosity is different from the second viscosity. The first fluid can have a higher viscosity, and the second fluid can have a lower viscosity. The material of the first fluid can be the same as the material of the second fluid. The material of the first fluid and the second fluid can be resin, silicone, epoxy, or polymer.

Step 130 is blending the first fluid and the second fluid in a predetermined ratio to obtain a third fluid with a third viscosity. The value of the third viscosity is between the first viscosity and the second viscosity. The value of the third viscosity can be decided according to the desired shape of the light emitting diode lens, and the blending ratio of the first fluid and the second fluid can be decided according to the predetermined third viscosity. For example, if a higher profile shape lens is desired, the third viscosity is needed to be higher; if a lower profile shape lens is desired, the third viscosity is needed to be lower. The target range of the third viscosity is preferably from 3000 cps to 300000 cps.

Step 140 is dispensing the third fluid on a light emitting diode. The light emitting diode is disposed on a substrate. The third fluid is dispensed on the light emitting diode and the substrate. The third fluid packages the light emitting diode. The dispense volume of the third fluid is decided according to the diameter of the desired lens.

Step 150 is curing the third fluid to form a lens on the light emitting diode. The shape of the lens is controlled by the third viscosity, which is determined according to the desired lens shape. The curing step can be UV curing, IR heat curing, moisture curing, or chemical curing. A curing temperature is preferably from 20° C. to 200° C. A curing pressure is preferably from 0.1 atm to 5 atm.

The third viscosity can control the lens shape; therefore the molding process can be omitted. The third viscosity can be determined according to the desired lens shape, and the blending ratio of the first fluid and the second fluid can be determined according to the predetermined third viscosity. The method of the invention may use only two fluids to produce a wide variety of lenses having specific lens shapes.

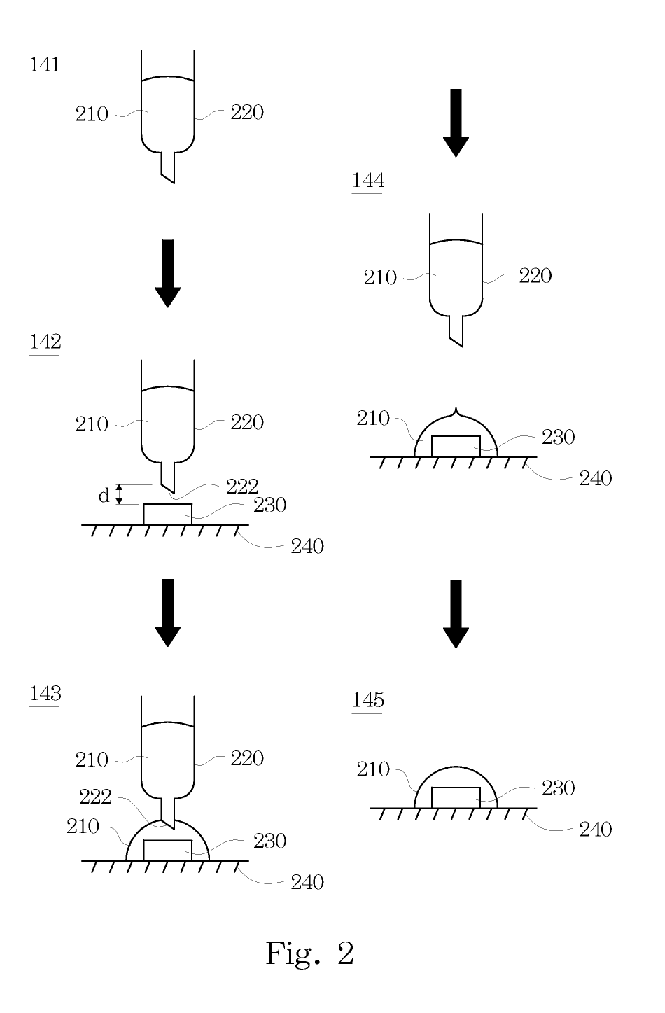

Refer to FIG. 2. FIG. 2 is a schematic diagram of an embodiment of the dispensing step of the invention. Step 141 is filling the third fluid 210 into an injector 220. Step 142 is positioning the injector 220. The injector 220 is positioned above the light emitting diode 230, which is disposed on the substrate 240. The injector 220 is positioned close to but is not in contact with the light emitting diode 230. The distance d between the outlet 222 of the injector 220 and the light emitting diode 230 is very short.

Step 143 is injecting the third fluid 210 in a predetermined volume. The outlet 222 is submerged by the third fluid 210 when the third fluid 210 is injected. Step 144 is pulling back the injector 220. A tip is formed temporarily when the injector 220 departed from the third fluid 210. Then step 145 is shaping the third fluid 210. The third fluid 210 is shaped due to the surface energy after a period of time. The viscosity of the third fluid 210 determines the shape thereof. The third fluid 210 is further cured to form the desired lens.

The lens formed in this embodiment could have a larger size due to controlling the third viscosity. The preferred range of the third viscosity is from 3000 cps to 300000 cps. The diameter of the lens is from 0.1 mm to 50 mm.

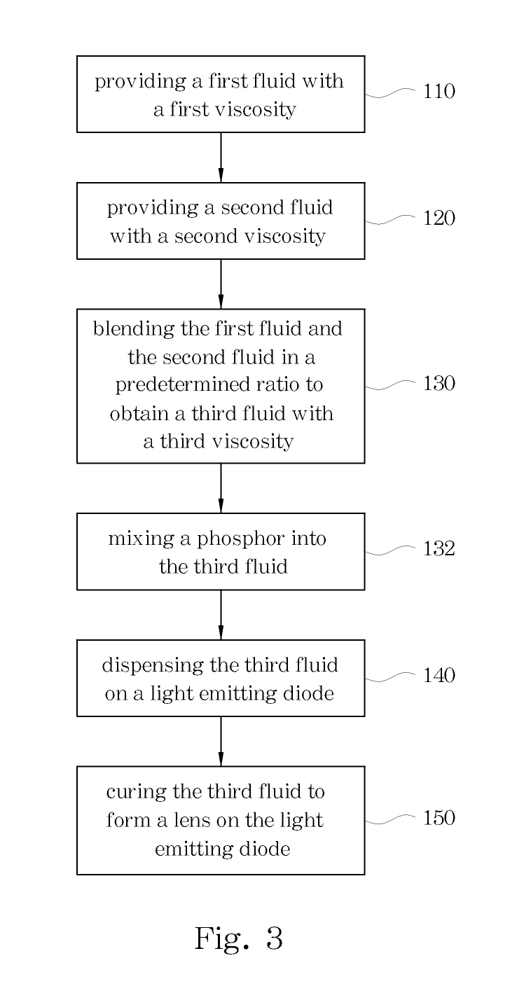

Refer to FIG. 3. FIG. 3 is a flow chart of another embodiment of the method for fabricating the self assembling light emitting diode lens of the invention. Step 110 is providing a first fluid with a first viscosity. Step 120 is providing a second fluid with a second viscosity. The refractive index of the first fluid is the same as the refractive index of the second fluid. The first viscosity is different from the second viscosity. The first fluid can have a higher viscosity, and the second fluid can have a lower viscosity. The material of the first fluid can be the same as the material of the second fluid. The material of the first fluid and the second fluid can be resin, silicone, epoxy, or polymer.

Step 130 is blending the first fluid and the second fluid in a predetermined ratio to obtain a third fluid with a third viscosity. The target range of the third viscosity is preferable from 3000 cps to 300000 cps.

Step 132 is mixing a phosphor into the third fluid. The phosphor can be selected according to the desired light color.

Step 140 is dispensing the third fluid on a light emitting diode. The light emitting diode is disposed on a substrate. The third fluid is dispensed on the light emitting diode and the substrate. The third fluid packages the light emitting diode. The dispense volume of the third fluid is decided according to the diameter of the desired lens.

Step 150 is curing the third fluid to form a lens on the light emitting diode. The shape of the lens is controlled by the third viscosity, which is determined according to the desired lens shape. The curing step can be UV curing, IR heat curing, moisture curing, or chemical curing.

This embodiment may further adjust the light color of the light emitting diode by mixing the phosphor into the third fluid. The third fluid is cured and a lens having phosphor within is provided to adjust the light color of the light emitting diode. The shape of the lens is also controlled by the third viscosity.

Refer to FIG. 4. FIG. 4 is a schematic diagram of a first embodiment of the lens fabricated by the method of the invention. The light emitting diode 310 is disposed on the substrate 320. The lens 330 is formed on the light emitting diode 310 and the substrate 320 by curing the third fluid with the predetermined third viscosity.

Refer to FIG. 5. FIG. 5 is a schematic diagram of a second embodiment of the lens fabricated by the method of the invention. The light emitting diode 410 is disposed on the substrate 420. The third fluid is mixed with a phosphor 440. Therefore the lens 430 formed on the light emitting diode has the phosphor 440 within.

Refer to FIG. 6. FIG. 6 is a third embodiment of the lens fabricated by the method of the invention. A cavity 540 is formed on the substrate 520. The light emitting diode 510 is disposed in the cavity 540. The lens 530 is formed on the light emitting diode 510. The shape of the lens 530 is controlled by the viscosity thereof, the surface energy relates to the properties of the substrate 520, and the diameter of the cavity 540. The lens 530 is a convex lens. The lens 530 may optionally include a phosphor within by mixing the phosphor into the third fluid.

The method disclosed in the present invention can further be used to fabricate a complex lens by dispensing a fourth fluid on the first lens to form a second lens. The shape of the second lens is controlled by the viscosity of the fourth fluid.

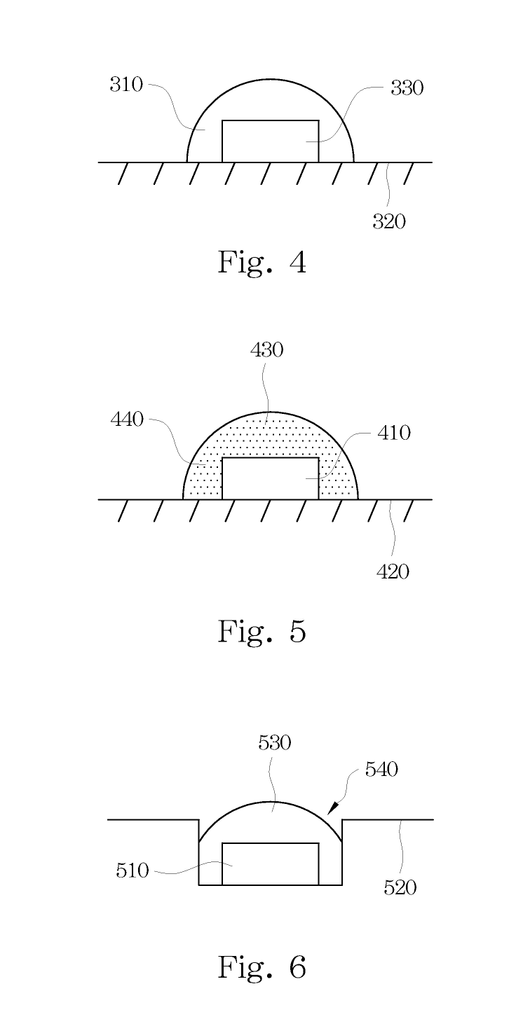

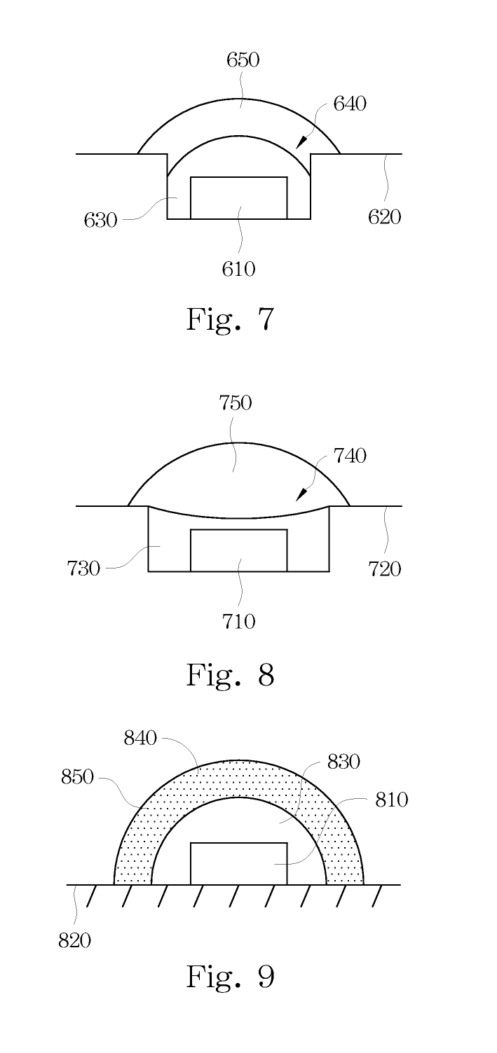

Refer to FIG. 7. FIG. 7 is a schematic diagram of a first embodiment of the complex lens fabricated by the method of the invention. A cavity 640 is formed on the substrate 620. The light emitting diode 610 is disposed in the cavity 640. A first lens 630 is formed on the light emitting diode 610. The shape of the first lens 630 is controlled by the viscosity thereof, the diameter of the cavity 640, and the surface energy related to the properties of the substrate 620. The first lens 630 is a convex lens in this embodiment. A fourth fluid can be further dispensed on the first lens 630 and be cured to form a second lens 650 on the first lens 630. The shape of the second lens 650 is mainly controlled by the viscosity of the fourth fluid. The refractive index of the first lens 630 is greater than the refractive index of the second lens 650. A phosphor (not shown) can be optionally added in the first lens 630 or the second lens 650.

Refer to FIG. 8. FIG. 8 is a schematic diagram of a second embodiment of the complex lens fabricated by the method of the invention. A cavity 740 is formed on the substrate 720. The light emitting diode 710 is disposed in the cavity 740. A first lens 730 is formed on the light emitting diode 710. The shape of the first lens 730 is controlled by the viscosity thereof. The diameter of the cavity 740 and the surface energy relates to the properties of the substrate 720. The first lens 730 is a concave lens in this embodiment. A fourth fluid can be further dispensed on the first lens 730 and be cured to form a second lens 750 on the first lens 730. The shape of the second lens 750 is mainly controlled by the viscosity of the fourth fluid. The refractive index of the first lens 730 is greater than the refractive index of the second lens 750. A phosphor (not shown) can be optionally added in the first lens 730 or the second lens 750.

Refer to FIG. 9. FIG. 9 is a schematic diagram of a third embodiment of the complex lens fabricated by the method of the invention. The light emitting diode 810 is disposed on the substrate 820. The third fluid is dispensed on the light emitting diode 810 and is cured to form the first lens 830 on the light emitting diode 810. The fourth fluid is further dispensed on the first lens 830 to form a second lens 840. The phosphor 850 is added in the fourth fluid in this embodiment.

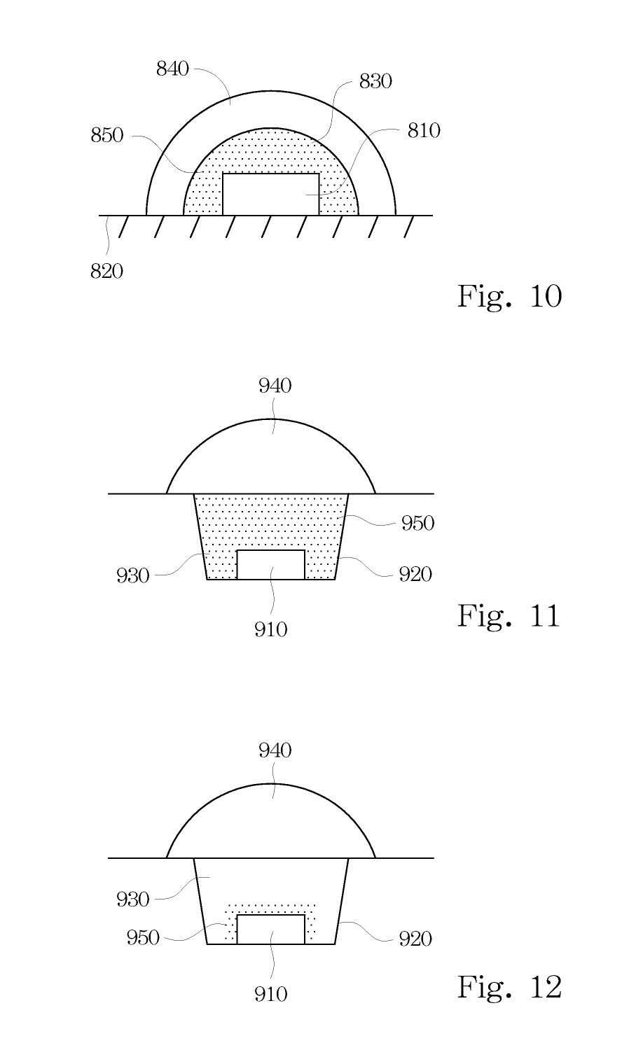

Refer to FIG. 10. FIG. 10 is a schematic diagram of a fourth embodiment of the complex lens fabricated by the method of the invention. The light emitting diode 810 is disposed on the substrate 820. The third fluid is dispensed on the light emitting diode 810 and is cured to form the first lens 830 on the light emitting diode 810. The fourth fluid is further dispensed on the first lens 830 to form a second lens 840. The phosphor 850 is added in the third fluid in this embodiment.

Refer to FIG. 11. FIG. 11 is a schematic diagram of the method utilized in a uniform distribution light emitting diode structure. The uniform distribution light emitting diode structure includes the cavity 920, the light emitting diode 910 disposed in the cavity 920, and the first lens 930 having the phosphor filled in the cavity 920. The phosphor 950 is disposed in the first lens 930 uniformly. The third fluid with the predetermined viscosity is dispensed on the first lens 930 to form a convex lens 940 with desired shape on the first lens 930.

Refer to FIG. 12. FIG. 12 is a schematic diagram of the method utilized in a conformal distribution light emitting diode structure. The conformal distribution light emitting diode structure includes the cavity 920, the light emitting diode 910 disposed in the cavity 920, and the first lens 930 having the phosphor 950 filled in the cavity 920. The phosphor 950 is disposed close to and surrounds the light emitting diode 910 to produce a conformally coated phosphor layer with uniform thickness. The third fluid with the predetermined viscosity is dispensed on the first lens 930 to form a convex lens 940 with desired shape on the first lens 930.

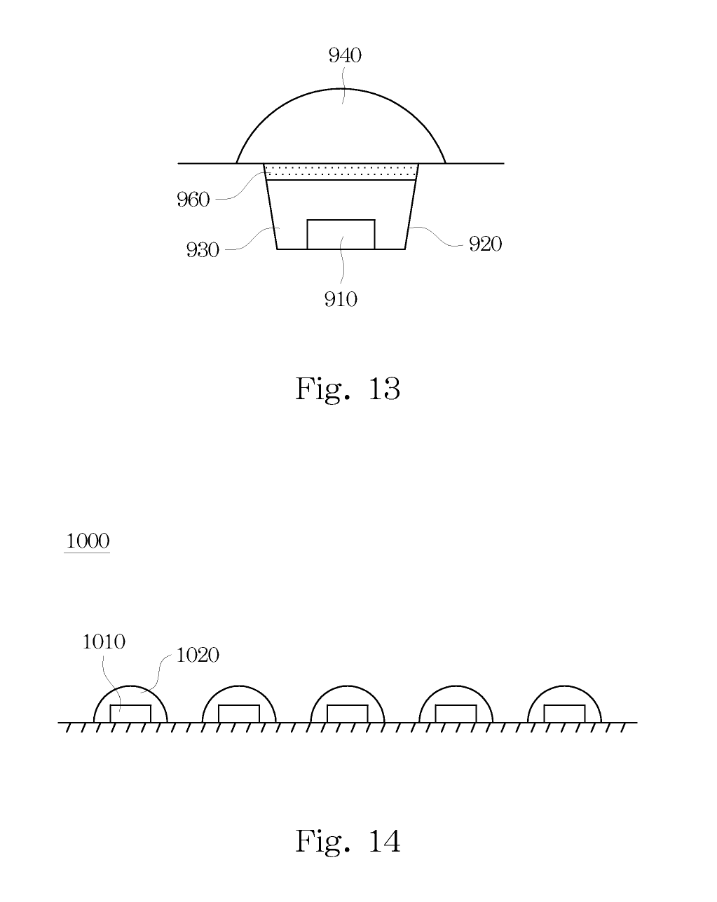

Refer to FIG. 13. FIG. 13 is a schematic diagram of the method utilized in a remote phosphor light emitting diode structure. The remote phosphor light emitting diode structure includes the cavity 920, the light emitting diode 910 disposed in the cavity 920, the first lens 930 filled in the cavity 920, and a phosphor layer 960 disposed on the first lens 930. A gap is formed between the light emitting diode 910 and the phosphor layer 960. The phosphor layer 960 does not contact the light emitting diode 910 directly. The third fluid with the predetermined viscosity is dispensed on the first lens 930 to form a convex lens 940 with desired shape on the first lens 930.

Refer to FIG. 14. FIG. 14 is a schematic diagram of a light emitting diode array fabricated by the method of the invention. The light emitting diode array 1000 includes plural light emitting diodes 1010 and plural lenses 1020 formed on the light emitting diodes 1010, respectively. The lenses 1020 are formed by curing the blended fluid with particular viscosity.

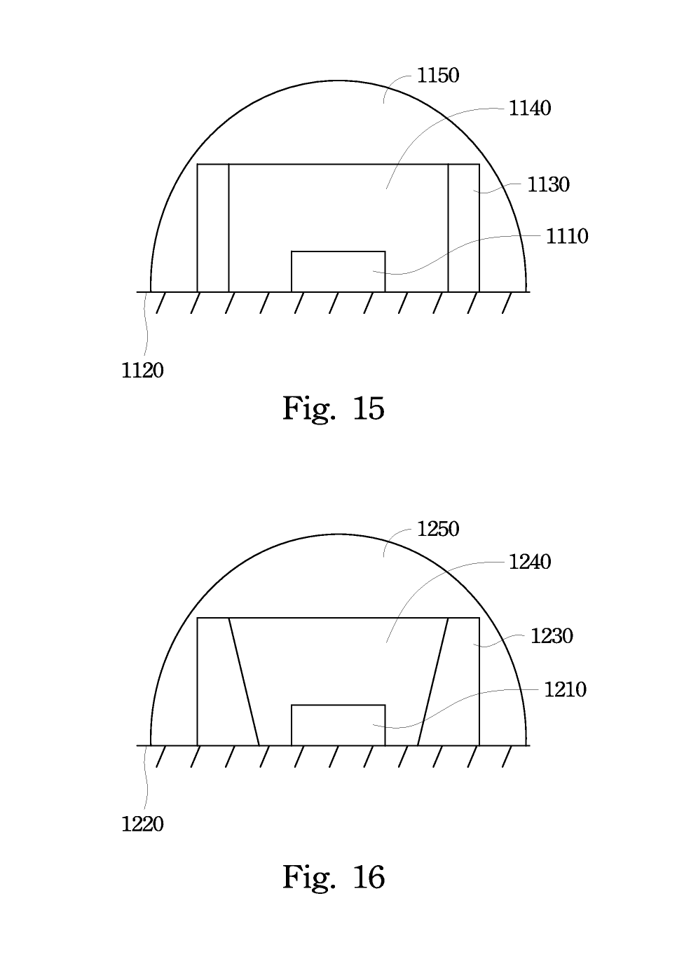

Refer to FIG. 15. FIG. 15 is a schematic diagram an embodiment of the light emitting diode package structure of the invention. The light emitting diode package structure includes the substrate 1120, the light emitting diode 1110 disposed on the substrate 1120, an enclosure 1130, a resin 1140, and the lens 1150. The enclosure 1130 is made of a transparent material. The enclosure 1130 is formed on the substrate 1120. The enclosure 1130 defines an area. The light emitting diode 1110 is disposed in the area. The resin material 1140 is filled in the area and covers the light emitting diode 1110. The lens 1150 formed by curing the blended fluid with particular viscosity is disposed on the resin 1140 and the enclosure 1130.

The material of the enclosure 1130 of the present invention is a transparent material, and the area defined by the enclosure 1130 in this embodiment has a circular shape, a rectangle shape, or an ellipse shape. However, persons skilled in the art may design the area defined by the enclosure 1130 into various geometrical shapes according to practical application requirements. The enclosure 1130 of this embodiment has a rectangular plate-like structure, and the enclosure 1130 is substantially perpendicular to the substrate 1120. However, the enclosure 1130 may also be designed as being disposed on the substrate 1120 at an angle of inclination. A phosphor (not shown) can be optionally disposed in the resin 1140 or the lens 1150.

Refer to FIG. 16. FIG. 16 is a schematic diagram an embodiment of the light emitting diode package structure of the invention. The light emitting diode package structure includes the substrate 1220, the light emitting diode 1210 disposed on the substrate 1220, the enclosure 1230, the resin 1240, and the lens 1250. The enclosure 1230 is made of a transparent material. The enclosure 1230 is formed on the substrate 1220. The enclosure 1230 defines an area. The light emitting diode 1210 is disposed in the area. The resin material 1140 is filled in the area and covers the light emitting diode 1210. The lens 1250 formed by curing the blended fluid with particular viscosity is disposed on the resin 1240 and the enclosure 1230. The enclosure 1230 is designed into a trapezoid-like structure. The phosphor (not shown) can be optionally disposed in the resin 1240 or the lens 1250.

Persons skilled in the art may further derive and design various geometrical shapes and different placement angles for the enclosure 1230 of the present invention according to practical application requirements, which are not limited to the embodiments of the present invention.

According to the present embodiments, the invention has the following advantages. The lens can be shaped by the viscosity of the fluid, therefore the molding process can be omitted. The blending ratio of the first fluid and the second fluid can be adjusted to tune the third viscosity, which decides the shape of the lens. A variety of lenses with different shape can be formed by blending two fluids by using the invention.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fabricating a self assembling light emitting diode lens comprising:
providing a first fluid with a first viscosity;
providing a second fluid with a second viscosity, wherein the refractive index of the first fluid is the same as the refractive index of the second fluid;
blending the first fluid and the second fluid in a predetermined ratio to obtain a third fluid with a third viscosity, wherein the third viscosity is from 3000 cps to 300000 cps;
dispensing the third fluid on a light emitting diode, which is disposed on a substrate; and
curing the third fluid to form a lens on the light emitting diode, wherein a shape of the lens is controlled by the third viscosity.

2. The method of claim 1, wherein the step of dispensing the third fluid on the light emitting diode comprising:
filling the third fluid into an injector;
positioning the injector, wherein an outlet of the injector is close to but not in contact with the light emitting diode;
injecting the third fluid in a predetermined volume, wherein the outlet is submerged by the third fluid; and
pulling back the injector.

3. The method of claim 1, further comprising adding a phosphor into the third fluid.

4. The method of claim 1, further comprising dispensing a fourth fluid with a fourth viscosity on the lens.

5. The method of claim 1, wherein the diameter of the lens is from 0.1 mm to 50 mm.

6. The method of claim 1, wherein the material of the first fluid and the second fluid is resin, silicone, epoxy, or polymer.

7. The method of claim 1, wherein a curing temperature is from 20° C. to 200° C.

8. The method of claim 1, wherein a curing pressure is from 0.1 atm to 5 atm.

9. The method of claim 1, further comprising forming a cavity on the substrate, wherein the light emitting diode is disposed in the cavity.
